(19) United States
(12) Patent Application Publication
(10) Pub. No.: US 2013/0184072 A1
(43) Pub. Date: Jul. 18, 2013

(54) Purchase System With Sweepstakes Gaming Option And Transformative Payout

(71) Applicant: Ultra Group USA, Inc., Norcross, GA (US)

(72) Inventor: Blake Foster, Norcross, GA (US)

(73) Assignee: ULTRA GROUP USA, INC., Norcross, GA (US)

(21) Appl. No.: 13/745,474

(22) Filed: Jan. 18, 2013

Related U.S. Application Data
(60) Provisional application No. 61/587,723, filed on Jan. 18, 2012.

(51) Int. Cl. A63F 13/10

(52) U.S. Cl. CPC A63F 13/10
USPC 463/29

(57) ABSTRACT

A system and method for consoles game play is disclosed. In some establishments limitations are placed on game play consoles. One such limitation is that of prohibiting consoles from accepting consideration directly at the console. Others prohibit consideration for play. By moving the situs of payment away from the console and disconnecting from same, and providing non-game value for consideration paid, the impediments may be circumvented. In another embodiment, user is able elect to participate in sweepstakes console games and use credits stored in a separate depository while funds initially provided are use only to buy goods or services unrelated to the games.

The following applications are incorporated by reference:
1. U.S. Provisional Application No. 61/366329 filed 21 Jul. 2010,
2. U.S. Provisional Application No. 61/383834 filed 17 Sep. 2010,
3. U.S. application Ser. No. 13/187731 filed 21 Jul. 2011, which hereby are incorporated herein by reference in its entirety.

### FIELD OF THE DISCLOSURE

The present disclosure is directed to the field of point of sale system with a sweepstakes gaming option via consoles therefore and networking between consoles and data storage devices.

### BACKGROUND

In the United States, there is considerable regulation of devices used for games of chance (gaming) by both governmental agencies and other non-governmental establishments, which may have their own rules. Each US state has its own regulations and even in some states, county and city and even the establishment where the game console is located may have its own regulations. Often these governmental or establishment (house) regulations can interfere with the enjoyment of the gaming experience. Therefore, it is important for a gaming system to be able to transform its play and create an outcome which is acceptable to the player yet remain in compliance with establishment rules.

One possible house/establishment regulation/requirement is that a sweepstakes/game which is incidental to the purchase of a product, is permitted, where direct purchase of sweepstakes purchases may be prohibited.

Furthermore, there may be a requirement that the console game not be allowed to accept cash or credit of any kind, at the console itself. These are potentially serious impediments to the enjoyment or even use of such a console game, since it is virtually impossible to have both good game flow (game to game) if consideration (money) can not be provided directly at the console. The present disclosure provides a method and apparatus to overcome such restrictions and still provide an enjoyable console game experience while remaining in compliance with establishment rules.

### DESCRIPTION OF THE RELATED ART

Electronic gaming machines (either gambling or games of skill) have been in use for many years and have the typical characteristic of one or more gaming consoles, a network interconnection and a central data manager which monitors the activities of the consoles and in some cases prints reward tickets or coupons redeemable for cash or prizes. Examples of such machines and systems are found in US 2008/0274795 to Carpenter et al, US 2006/287072 to Walker et al, US 2009/0286603 to Mori, US 2008/0287196 to Miki et al and US 2002/0194014 to Starnes et al.

### BRIEF SUMMARY

Briefly stated, to avoid complications with established rules prohibiting direct insertion of cash/cash value at a gaming terminal to initiate play, the game operating system transforms the physical process so that the operation (initiation of play and extraction of winnings) at the game console is accomplished with essentially no physical connection between the acceptance of consideration (money) and the play of the game. One way to accomplish this is to accept consideration in exchange of goods or (non gaming) services and offer access to the game console as an added benefit to the initial transaction.

The present disclosure is to a method, a system, and software for carrying out the concepts disclosed.

In one preferred embodiment of the present invention, a software system coded in a dedicated gaming machine which allows the purchaser to pay for long distance calling cards issued as pin codes for accessing long distance phone dialing. The purchaser is also given additional access to game consoles (plays) as an alternative benefit to the purchase of goods/service.

Preferably the compensation given to the player is in a form unrelated to game play, thereby insulating the game from being funded directly by the player. It is merely an adjunct. This is accomplished by sending credits to the console at a front server not from the money acceptor. There is no money acceptor on the console and the consoles, once activated by credits, is an independent game playing entity. It is also possible that the form of value/compensation unrelated to the game play or initial funds received, can be a different form of payment, for example, goods or goods vouchers instead of cash/credit , which is typically used by the funds receiver.

Such a system can be further improved by:
a. having a computer based funding based system which first accepts payment for goods or services;
b. offers the user the opportunity to play a sweepstakes game in the form of a terminal/console based game with the potential for winning points/prizes/goods/etc;
c. if the user elects to play the sweepstakes/game the winnings from the game are available for cash/product payout or can be used directly for further play without having to go back to the cashier to redeposit the winnings.

This ability to continue play with the winnings enhances the game flow which would be interrupted by going back to a cashier but does not violate the house rule that the consoles cannot accept value directly.

Furthermore, since many regulations require that sweepstake games have a prefined (not random) number of winners, the game may use a finite table winning entries which then correspond to a winning amount and a display set which will appear on screen. Thus, while the user /game player appears to seeing a random display of visual sets (such as alignment of symbols on a slot machine) the system actually selects the next data set from a data table, which includes data as to whether it is a winning combination, the amount to be won and the visual set which is to be displayed for that data set. This insures that a defined number of winners will be selected for a finite amount of plays.

Further, in a gaming area, it is possible that the games will be owned by different parties, without the user being aware of the ownership arrangement. To allow the user the freedom to move from one terminal/console to another, the disclosure provides for a “banking” arrangement whereby the winning accumulated on one terminal can be transferred to another and the appropriate terminal owner at the time of winning will receive credit.

In another embodiment, a computer based system of funding a dedicated game playing console from a remote location not directly connected to the console has any or all of the following steps in any order:
a. establishing communication between a plurality of gaming consoles and a gaming console server machine configured for that purpose;
b. receiving funds from a player at a funds receiver located distant from and detached from the console to be played and from the server;
c. according to the amount of funds received, having a machine dispense consideration to the player in a form unrelated to game console play;
d. computer formatting the value into an output according to predetermined criteria;
e. computer authorizing game play from a server;
f. at the termination of game play, receiving data from the console as to balances generated;
g. computer generating a form of value in a tangible form to the game player, the form being unrelated to game play thereby transforming funds initially received, into value unrelated to the outcome of the game play.

Additionally, there be the additional steps that transform the data into a telephone calling card format and wherein said accounting server retrieves card pin numbers from a pin data base and formats them to print on said cards.

Additionally, there be the following steps of having gaming server located at a cashier station and wherein funds are received at said cashier station and wherein said cashier station and said consoles are incapable of directly transmitting funds authorization signals capable of activating consoles.

A further disclosure is a machine system for funding game play at a console in jurisdictions which prohibit direct payment at the console having any or all of the following elements:
a. an accounting server;
b. a plurality of dedicated gaming consoles in communication with said accounting server;
c. a funds acceptor, located distant from said consoles capable of accepting funding and transmitting the accepted value to said accounting servers, said accounting server capable of converting information from the funding acceptor to a corresponding number of PINs; said server configured to transmit said pins to a selected printer;
d. an advertising merger machine which merges advertising data at print time, to produce a printed output with PIN number information and advertising.

Further features may be where said PINs are authorization codes for a telephone calling card and wherein said system further includes a PIN number data base machine and wherein said merging control unit merges the winnings output with PIN numbers to produce a telephone calling card with PIN number.

In another embodiment a method is disclosed which employs some or all of the following steps to transform a console game from a gambling activity to a sweepstakes on a console, having any of the following steps:
a. receiving funds from a player at a funds receiver electronically independent from the console to be played, said funds being used to authorize the console;
b. in response to funds received, providing the user with a first depository credits usable for goods or services commensurate to the value of the funds and storing credits for such funds therein; querying the user for the opportunity to play a sweepstake game at the console, and if yes, independently of the first depository credits providing the user with a predetermined number of second depository credits against which play is authorized and storing said credits in a second depository thereby transforming said game into a non-gambling sweepstakes;
c. accessing a finite data table of game outcomes having a predetermined percentage of winning combinations randomly organized;
d. in response to each game played by the user, drawing the next available game outcome from the data table and displaying the outcome on the screen;
e. for games where the user wins, adding a predetermined number of credits to said depository;
f. querying the user whether to use credits from the depository to play an additional game or transfer the credits to be paid out, permitting the user to transfer credits from one console to another, concatenating information to the credits as to which console there are currently located on, and then changing such location information to a different console and then authorizing further play on said different terminal.

In another embodiment there is disclosed a method of authorizing access to a dedicated game playing console, from a remote location, the gaming console containing software for local game play of the game thereon, comprising any of the steps of:
a. establishing communication between at least one gaming console and a gaming console server;
b. receiving funds from a player at a funds receiver electronically independent from the console to be played, said funds being used to authorize the console;
c. in response to funds received, storing the value received from the user in a first depository in the form of credits usable for goods or services commensurate to the value of the funds; in response to user input playing a sweepstake game at the console; independently of the first depository credits providing the user with a predetermined number of second depository credits against which play is authorized and storing said credits in a second depository thereby transforming said game into a non-gambling sweepstakes;
d. accessing a finite data table of game outcomes having a predetermined percentage of winning combinations randomly organized;
e. in response to each game played by the user, drawing the next available game outcome from the data table and displaying the outcome on the screen for games where the user wins, adding a predetermined number of credits to said depository;
f. querying the user whether to use credits from the depository to play an additional game or transfer the credits to be paid out, querying the user whether to continue plan on the same console or an alternate console, and in the event of electing a new console permitting the user to transfer credits from one console to another, transferring the credits to said new console and concatenating or linking a console identifier to the credits to identify the location at which they are used for play;
g. depositing remaining credits after play into a third winnings depository.

Also disclosed is a computer software system for transforming a console game from a gambling activity to a sweepstakes on a console, having some or all of the following elements:
a. a funds receiver for accepting funds from a player said receiver being electronically independent from the console to be played, said funds being used to authorize the console;
b. a first credits register for storing funds received, providing the user with a first depository credits usable for goods or services commensurate to the value of the funds and storing credits for such funds therein;
c. a second credits register for storing credit accumulated through game play, said second register being separate from said first register so that credits are not comingled;
d. a console display running credit management software including a routine for querying the user for the opportunity to play a sweepstake game at the console, and if yes, independently of the first depository credits, said routine providing the user with a predetermined number of second credit register against which play is authorized and storing said credits in a second register thereby transforming said game into a non-gambling sweepstakes;
e. finite data table of game outcomes having a predetermined percentage of winning combinations randomly organized;
f. a software routine initiated, in response to each game played by the user, to draw the next available game outcome from the data table and displaying the outcome on the screen;
g. an accumulator for use when the user wins a game to add a predetermined number of credits to said second register;
h. a further software routing for querying the user whether to use credits from the second register to play an additional game or transfer the credits to be paid out;
i. a further software routing for permitting the user to transfer credits from one console to another, which tracks credits as to which console there are currently located on by adding location information to the credits, and then changes such location information to a different console and then authorizing further play on said different terminal.

Also disclosed is a system wherein said credits in the second and third depositories are combined and transmitted to a cashier for payout.

Also disclosed is a system wherein said credits in the second and third depositories are combined on user request and a voucher is issued for payout.

This summary is designed to assist the reader in understanding some of the concepts disclosed herein but it does not define the scope of protection. That is determined by the claims.

### BRIEF DESCRIPTION OF THE SEVERAL VIEWS OF THE DRAWINGS

It should be understood that the drawings do not define the scope of the invention but are used to assist the reader in understanding some of the embodiments thereof.

FIG. 1 illustrates a prior art system of interconnected gaming consoles.

FIG. 2 a gaming system according to one embodiment of the present invention.

FIG. 3 is a flow chart of another embodiment of the gaming system.

FIG. 4 is a flow chart of another embodiment of the gaming system.

FIG. 5. is a flow chart of a further embodiment.

FIG. 6 is an additional flow chart of a further embodiment.

### DETAILED DESCRIPTION

Unlike casino gambling, where console based machines are clearly games of chance, and regulated as such, there is another class of gaming which, under certain US state laws, is exempt from the rigorous controls associated with gambling machines. Typically such consoles provide exactly the same game experience as gambling consoles but they include a “skill” requirement.

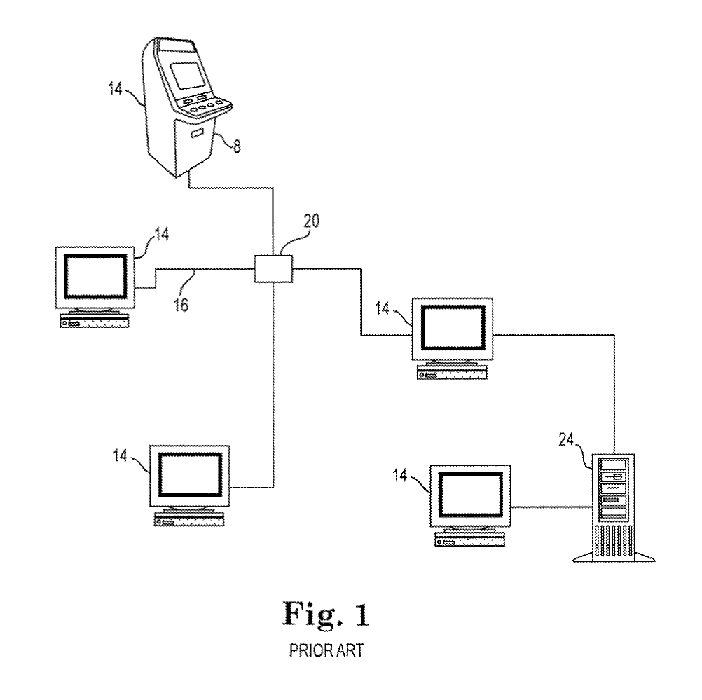

Heretofore, it was a basic feature of such skill gaming machines to have bill (money) acceptors on the front of each console. This made it easy for the user to play multiple games. The consoles could be networked primarily for the purposes of accounting and winning verification and reporting, but otherwise, they can operate independently. FIG. 1 illustrates a prior art construction involving an array of consoles 14 which are interconnected by known network topology such as Ethernet or if over the internet TCIP using a hub 20, or by direct connect, all feeding to a central processor 24.

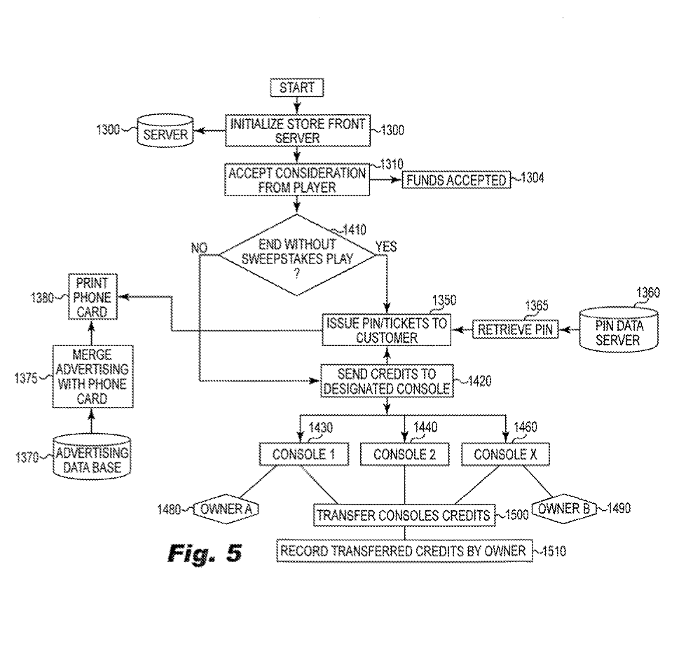

FIG. 5 illustrates another embodiment wherein the like numbers increased by one hundred have like meaning. In this embodiment, the purchaser, after payment, is given the option 1410 to redeem the payment for goods/services, in this example telephone cards, or to additionally play a sweepstakes game. If the game is elected (option NO) a certain number of credits are sent to a game console 1420, as well as goods, such as pins, are sent to the pin output (1350, 1380). In other words, the player/user received both, but the credits are, in effect, not purchased. Thus, there is created three “buckets”/depositories of value. One which is converted into goods/services (f. ex. pins) and a second bucket which is used to store credits provided for game play and the third is where credits are deposited from winnings. In practice depositories 2 and 3 can be the same but to comply with regulations it is beneficial to have the second bucket completely independent of the purchase of pins (first bucket).

The credits are sent by the controller (f. ex. cashier) to one of the plurality of consoles for game play.

A player may wish to transfer credits from one console to another because the game on the other console may be different and provide renewed interest. This may be permitted but tracking is desirable.

In some cases the ownership of the various consoles may not be the same. In this case consoles 1 and 2 (1430, 1440) are owned by one entity 1480 and the remaining console 3 (1460) is owned by a second entity 1490. It may be necessary to transfer credits from one console to another even if not owned by the same entity. Because the entities may get paid according to how many credits were played on their console, or how many credits were originally transmitted to that console, or even how many credits passed thru that counsel, etc. it is necessary to track the history of the credits. A “banking” routine or server 1500 tracks the origins and path of each credit and keeps an accounting 1510 so that payments can be split according to the appropriate rule. For example, if full credit is given to the owner of where the credits were played, that information would be accumulated and stored regardless of the transit path of the credits. Another possibility is that partial credit is given to the owner of each console where credits appeared and the remaining credit where the credits were played out.

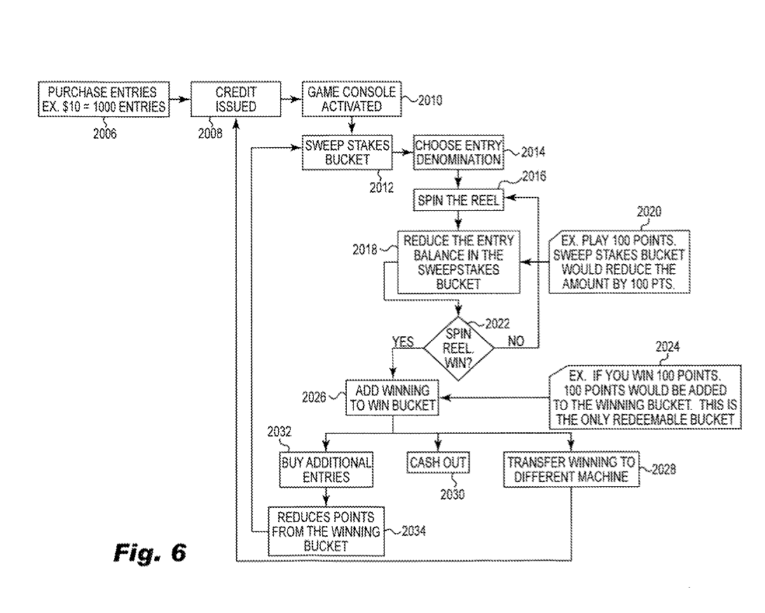

FIG. 6 provides a sample of game play according to this embodiment. For example, a user may purchase $10 of value which is then paid out in goods/services 2006 , such as telephone cards, or gift cards for later redemption. At the same time, if the user elects to play the sweepstakes, a certain number of credits are provided 2008 and a game console of choice is activated 2010 where the credits reside is this so called second bucket 2012.

The user decides on how much to play 2014 and operates the game, usually an electronic version of a spinning wheel 2016, as in a slot machine. The game play costs credits which are deducted 2018 reducing the bucket amount 2020. In the case of a win, 2022 the player can play again or add the credits in to the winnings bucket 2026.

At the end of play on that console, the player can 1) transfer credits to a new machine 2028, cash out 2030 (ie. redeem credits for value) or buy additional credits 2032. Depending on the local regulation, the additional credits can be purchased at the console or if required, at the cashier, without direct connection to the console. Then if the user wants to continue play, the win bucket is decremented by the amount to be played 2034 and play continues.

One possible way to transfer between terminals is to provide for a screen option such a “transfer to terminal”and display all available terminals which are unoccupied and operational. Another option is to print a voucher with a code number which leads to access of that user's winning bucket/balance. Alternatively a swipe card (magnetic/chip) can store that information. The user can input the code at any free terminal immediately or come back at a later time to resume.

Since some local rules require a defined win percentage to be applied to consoles or known by the player in advance, random selection of winners is not possible. Instead, a data base of a finite number of wins and losses, their amounts (of winnings) and visual display is created. The visual display indicia corresponds to the nature of the game. For example in a simple slot machine, the symbols could be three types of fruits where the winning combination are fruits of the same type. Thus the data table includes type of indicia, its value (the winnings). The console merely plays thru the entire finite data table and at the end restarts from the beginning. By that means, the win percentage will never change and can be advertised in advance of play.

This method can also be practiced as system or computer program.

In the present disclosure, the system and method are directed to computers or similar machines and the data which they obtain is then transformed into actions, products and outputs which are substantially different from the data input. The actions are counter-intuitive and opposite of teachings of the prior art.

In FIG. 1, the consoles 14 each include a bill/coin/credit card acceptor device often located on the console or immediately adjacent to the screen or operating controls. It is therefore trivial for a user to insert funds into the acceptor, play and insert further funds. Winnings can be paid out in cash, tokens, more plays, prepaid phone cards or other similar consideration.

In some circumstances the mere proximity of the acceptor within reach of the console is prohibited. This makes the prior art methods unusable.

The present disclosure provides a method and structure to avoid the problem of the prior art.

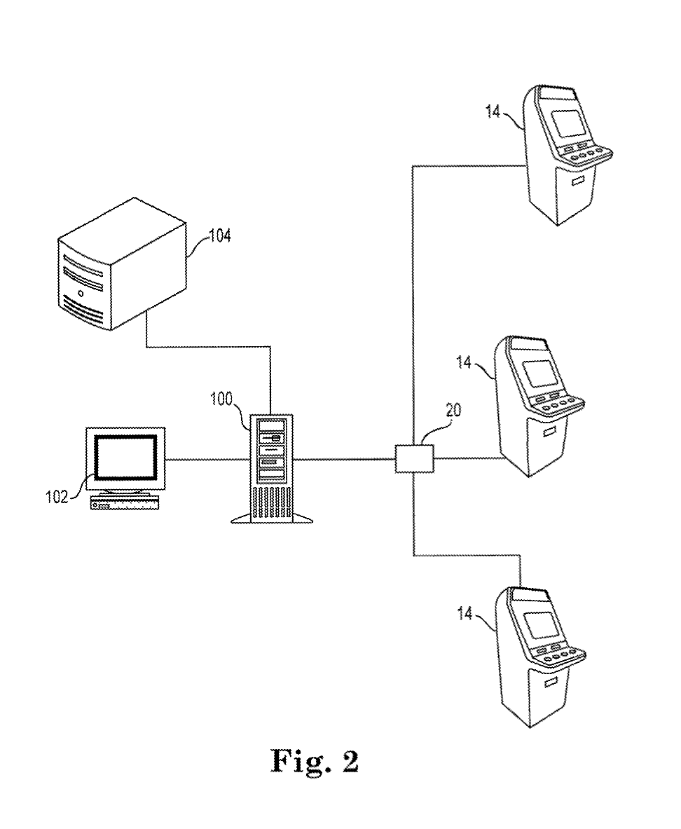

FIG. 2 illustrates, diagrammatically, the disclosed topology.

A data base manager/accounting server 100 which may be dedicated to servicing gaming consoles and which may include accounting and console management software routines and which manages funds and winnings (ie. balances remaining on the consoles after play is completed) as will be explained herein. It does not control the game consoles 14 with respect to the game activity running on each but monitors the winnings/balances, authorizes (activates) play, reconciles winnings, converts them to points or other indicia of value, with data retrieved from the consoles, for example by printing a winnings/balance payout tickets or equivalent. Terminal 102 is connected to server 100 and is typically located near a cashier station at the user site. Funds acceptor 104 is also connected to the server 100 and preferably is located adjacent terminal 102, but in any case, must be located distant/remote/detached/independent from consoles 14. Remote may mean electronically remote/detached, physically remote/detached or both. Independent means that there is not link between the console and funds acceptor. It may also mean that no connection whatsoever exists between the two. Normally each console 14 would have its own funds acceptor (a device for receiving numerous possible payment sources: cash, check, cards etc). However, in this embodiment it is completely prohibited to have a funds acceptor on the console or perhaps in the users reach of the counsel when playing (hence, the dotted line in FIG. 2).

One alternative option would be to provide for a bill acceptor or emulator on the console which accepts tokens (non money equivalents, including cards, bar codes, RFID, etc) which are not monetary instruments but can be used to activate a console to a predetermined point balance corresponding to the point value assigned to the token. This may satisfy the local rules that consoles may not accept money. If the token is provided as an adjunct to the purchase of goods or phone cards, for example, the token may not be considered to have any monetary value.

For the user to activate any of the consoles 14, he/she has to provide the cashier with funds and that value will be transmitted to the appropriate console by the terminal operator, but not via the network which links the console to the server. The console will be initialized and authorized for a predetermined number of “points”, plays or tokens after which the user may commence play.

At some point the user will have used up all points and then have to return to the cashier at terminal 102 to add authorizations, or “cash out” of balances unspent.

Cashing out can occur if the user has points or plays remaining. Communication between the console 14 and server 100 will let the cashier at terminal 102 know the point value remaining, or the console could print a ticket which can be hand carried with that information.

The point value has to be converted to some output form which is authorized under that particular jurisdiction's law. In many establishments, no money or only a small amount of money can be paid out. A form of payout is in the form of telephone access cards which provide long distance phone service for a predetermined number of minutes.

Generating such cards requires the use of an available PIN code which is known to be active with the long distance phone service. The PIN codes are purchased from the long distance supplier in large blocks and in the preferred embodiment are stored on a ROM or USB RAM in encrypted form. The server's routines converts points into a particular number of phone minutes or phone cards of 1 minute each and draws available PIN codes from the available block in ROM. The used codes are flagged as used so that they cannot be reused.

A print routine within the server then formats the output as desired. In the preferred embodiment, it is formatted as a phone card with PIN code. Further, the remaining space on the card can be used for user specific advertising. A data base of advertisers/enterprises may purchase this space to be printed on-demand as the cards are generated. Known data mining techniques can be employed to enhance the attractiveness of the advertising message that may be carried if demographic or geographic information is available.

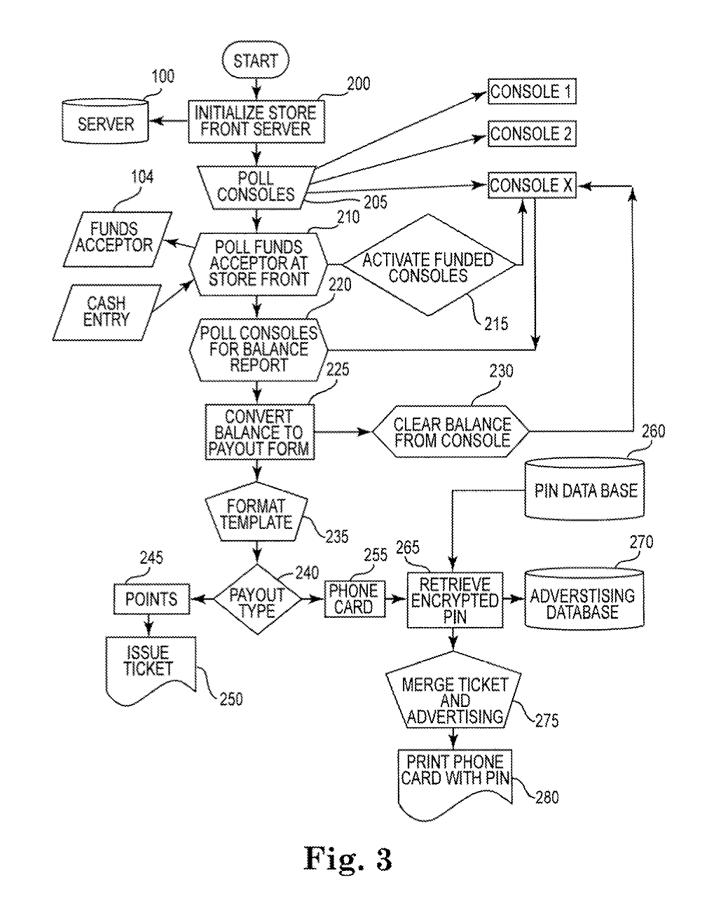

Turning to the flow chart in FIG. 3, the server 100 is initialized (200). Each of the consoles 14 may be polled (205) to insure that they are operational and ready to be activated for game play.

A player will then deposit funds with the cashier at the store front perhaps where the funds acceptor is located (distant or at least independent of any connection to the consoles) and in any event, the funds acceptor is not connected to the consoles. In the alternative, the cash can be provided to the cashier who punches up the amount into a dedicated machine whose data is then transferred into the computer/server, but again the console is never in direct connection with the funds acceptor. The system polls the funds acceptor (210) and activates (215) those consoles which were identified when the funds were taken in. This step is preferably manual, ie. an operator actually polls the acceptor and manually inputs the data into the server to be forward to the console so that there is no electronic connection between the console and the funds acceptor.

The funded console will then operate independently except that it may be reporting its status back to the server (not the consoles) from time to time or at least when the user/player wishes to redeem winnings.

When the player ends play on a console, if he/she has points left for redemption (ie. a balance), he/she can activate a redeem button on the console which will transmit a report (220) to the server whereupon (or manually print a ticket with the winnings/balance printed thereon), the winnings/balance information will be converted (225) to a payout format by a winning payout control (usually the sever). This can be points, cash, goods, or preferably, telephone calling cards, depending on what is allowed in that establishment's rules or other restrictions.

The console which is redeeming, will be cleared (230) of previous balances or winning tallies. The payout type (240) will determine the format (240) of the payout printout. For example, for points (245) a ticket stub may be redeemed and used later for further play. For phone cards (255), a database of encrypted pins (260) will be interrogated (265) and pins will be associated with cards to be printed. Optionally the cards can be imprinted with advertising (275) from an advertising data bank (270) and a phone card can be printed with the merged data, advertising and pin (280).

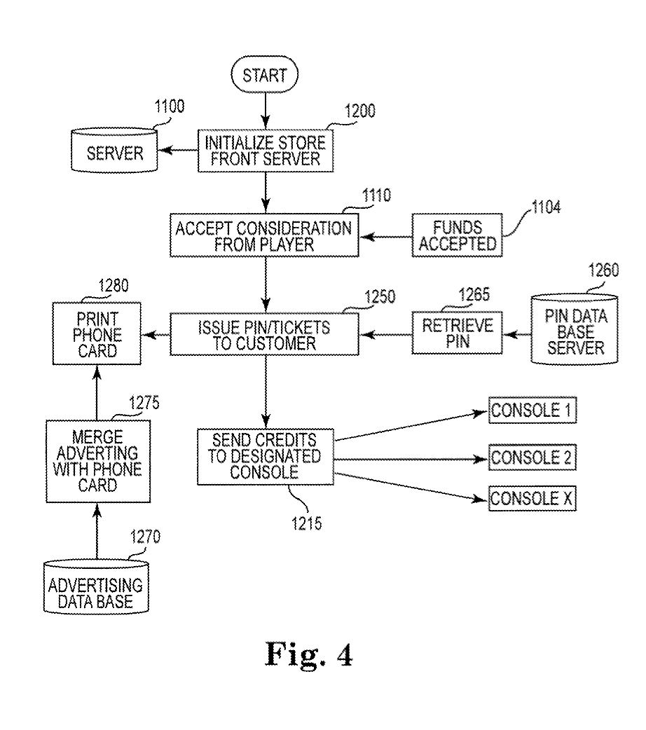

FIG. 4 illustrates an alternate embodiment. To the extent the functions of the various flow chart blocks are the same or similar to blocks in FIG. 3, they have the same numbering increased by 1000, so the initialization step 200 in FIG. 3, appears as 1200, in FIG. 4.

As in the prior embodiment, the storefront server is initialized 1200 by server 1100. Unlike the previous embodiment, the player/consumer makes a purchase of goods/(non-game) services. This can be anything so long as it is unrelated to play on the consoles. In the preferred case, the store front server accepts consideration 1110, such as cash, in exchange for, for example, long distance phone cards which are created by merging a print function 1250, 1280 with pin codes from a pin data base 1260, 1265. Optionally, the pin carrying cards may include user or geography specific advertising or marketing promotions 1275 from a database 1270. Thus the initial transaction has two characteristics 1) the funds acceptor (or other cash/credit acceptance modality) does not activate the consoles directly and 2) the player is given consideration script, such as a voucher, telephone calling cards, etc, (or something else of value) which is compensation for the funds received, in this case, calling minutes on a phone card/cards. In a further embodiment, the funds acceptor can be linked electronically to the consoles, but the purchase receives something of value (consideration) other than game plays and the game plays are incidental “bonus” benefits.

With the calling card transaction complete, the store front operator may activate one of the several game playing consoles by sending a credit authorization/activation signal to any of the consoles. Once the console receives this activation signal, it can operate independently according to the rules defined by the game console itself. Notice that in the preferred embodiments, the user/player never provides direct consideration into a console. In FIG. 4 the user/player actually receives non-game value as his/her consideration for cash paid in and the game play becomes an incidental benefit. In one embodiment, the consoles have no funds acceptors on their chassis.

The description of the invention and its applications as set forth herein is illustrative and is not intended to limit the scope of the invention. Variations and modifications of the embodiments disclosed herein are possible, and practical alternatives to and equivalents of the various elements of the embodiments would be understood to those of ordinary skill in the art upon study of this patent document. These and other variations and modifications of the embodiments disclosed herein may be made without departing from the scope and spirit of the invention.

1. A method of authorizing access to a dedicated game playing console, from a remote location, the gaming console containing software for local game play of the game thereon, comprising the steps of:
a. establishing communication between at least one gaming console and a gaming console server;
b. receiving funds from a player at a funds receiver electronically independent from the console to be played, said funds being used to authorize the console;
c. in response to funds received, storing the value received from the user in a first depository in the form of credits usable for goods or services commensurate to the value of the funds; in response to user input playing a sweepstake game at the console, independently of the first depository credits providing the user with a predetermined number of second depository credits against which play is authorized and storing said credits in a second depository thereby transforming said game into a non-gambling sweepstakes;
d. accessing a finite data table of game outcomes having a predetermined percentage of winning combinations randomly organized;
e. in response to each game played by the user, drawing the next available game outcome from the data table and displaying the outcome on the screen for games where the user wins, adding a predetermined number of credits to said depository;
f. querying the user whether to use credits from the depository to play an additional game or transfer the credits to be paid out, querying the user whether to continue plan on the same console or an alternate console, and in the event of electing a new console permitting the user to transfer credits from one console to another, transferring the credits to said new console and concatenating a console identifier to the credits to identify the location at which they are used for play;
g. depositing remaining credits after play into a third winnings depository.

2. The system of claim 1 wherein said credits in the second and third depositories are combined and transmitted to a cashier for payout.

3. The system of claim 1 wherein said credits in the second and third depositories are combined on user request and a voucher is issued for payout.

4. A method of transforming a console game from a gambling activity to a sweepstakes on a console, comprising the steps of:
a. receiving funds from a player at a funds receiver electronically independent from the console to be played, said funds being used to authorize the console;
b. in response to funds received, providing the user with a first depository credits usable for goods or services commensurate with the value of the funds and storing credits for such funds therein;
c. querying the user for the opportunity to play a sweepstake game at the console, and if yes, independently of the first depository credits providing the user with a predetermined number of second depository credits against which play is authorized and storing said credits in a second depository thereby transforming said game into a non-gambling sweepstakes;
d. accessing a finite data table of game outcomes having a predetermined percentage of winning combinations randomly organized;
e. in response to each game played by the user, drawing the next available game outcome from the data table and displaying the outcome on the screen;
f. for games where the user wins, adding a predetermined number of credits to said depository;
g. querying the user whether to use credits from the second depository to play an additional game or transfer the credits to be paid out. permitting the user to transfer credits from one console to another, linking information with the credits as to which console there are currently located on, and then changing such location information to a different console and then authorizing further play on said different terminal.

5. A computer based system for transforming a console game from a gambling activity to a sweepstakes on a console, comprising:
a. a funds receiver for accepting funds from a player said receiver being electronically independent from the console to be played, said funds being used to authorize the console;
b. a first credits register for storing funds received, providing the user with a first depository credits usable for goods or services commensurate to the value of the funds and storing credits for such funds therein;
c. a second credits register for storing credit accumulated through game play, said second register being separate from said first register so that credits are not comingled;
d. a console display running credit management software including a routine for querying the user for the opportunity to play a sweepstake game at the console, and if yes, independently of the first depository credits, said routine providing the user with a predetermined number of second credit register against which play is authorized and storing said credits in a second register thereby transforming said game into a non-gambling sweepstakes;
e. finite data table of game outcomes having a predetermined percentage of winning combinations randomly organized;
f. a software routine initiated, in response to each game played by the user, to draw the next available game outcome from the data table and displaying the outcome on the screen;
g. an accumulator for use when the user wins a game to add a predetermined number of credits to said second register;
h. a further software routing for querying the user whether to use credits from the second register to play an additional game or transfer the credits to be paid out;
i. a further software routing for permitting the user to transfer credits from one console to another, which tracks credits as to which console there are currently located on by adding location information to the credits, and then changes such location information to a different console and then authorizing further play on said different terminal.
